(19) United States
(12) Patent Application Publication
(10) Pub. No.: US 2008/0307609 A1
(43) Pub. Date: Dec. 18, 2008

(54) Hinge

(76) Inventors: Chung-Yu Lee, Shulin City (TW); Ting-Hsien Wang, Shulin City (TW)

Correspondence Address: Hershkovitz & Associates, LLC, 2845 Duke Street, Alexandria, VA, 22314, US

(21) Appl. No.: 11/812,261

(22) Filed: Jun. 15, 2007

(51) Int. Cl. E05D 7/00

(52) U.S. Cl. 16/382

(57) ABSTRACT

A hinge connects a display to a base of a notebook. The display has two sides and a bottom edge. The hinge has a stationary leaf, a bearing, a bracket and two pivoting leaves. The stationary leaf is mounted on the base. The bearing is formed on and at a relative incline to the stationary leaf. The bracket is parallel with respect to the base, but when the bracket rotates on the bearing, the bracket changes angle relative to the base until the bracket corresponds to the incline of the bearing. This raises an end of the bracket over the base and allows the display to rotate.

### BACKGROUND OF THE INVENTION

1. Field of the Invention

The present invention relates to a hinge, and more particularly to a hinge that connects a display having a bottom and a base of a notebook and allows the display to pivot and rotate without the bottom of the display hitting the base.2.

2. Description of Related Art

Notebooks are light, compact and becoming ubiquitous. A conventional notebook has a base, a display and a hinge. The hinge connects the display pivotally to the base so that the display serves as a cover and is able to pivot relative to the base to open or close the notebook.

Another notebook has been developed to allow a person other than a notebook user to watch the display. The notebook has a base, a display and a hinge. The base has a keyboard. The hinge connects the display pivotally and rotatably to the base so that the display is able to rotate horizontally relative to the base. A person other than the notebook user may watch the display by rotating the display. However, to rotate the display, the display must be pivoted to be exactly perpendicular to the base or the display may intercept the keyboard and prevent further rotation.

To overcome the shortcomings, the present invention provides a hinge to mitigate or obviate the aforementioned problems.

### SUMMARY OF THE INVENTION

The main objective of the invention is to provide a hinge that connects a base to a display of a notebook and allows the display to pivot and rotate relative to the base. A hinge in accordance with the present invention connects the display to a base of a notebook. The display has two sides and a bottom edge. The hinge has a stationary leaf, a bearing, a bracket and two pivoting leaves. The stationary leaf is mounted on the base. The bearing is formed on and at a relative incline to the stationary leaf. The bracket is parallel with respect to the base, but when the bracket rotates on the bearing, the bracket changes angle relative to the base until the bracket corresponds to the incline of the bearing. This raises an end of the bracket over the base and allows the display to rotate. Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2A is an exploded perspective view of the hinge in FIG. 1;

FIG. 2B is an exploded perspective view of the hinge in FIG. 1 from a different angle;

FIG. 3A is an operational side view of the notebook and the hinge in FIG. 1 showing a cover rising over a base,;

FIG. 3B is a side view in partial section of the hinge in FIG. 3A; and

FIG. 4 is an operational top view of a bracket rotating on a bearing.

### DETAILED DESCRIPTION OF THE PREFERRED EMBODIMENT

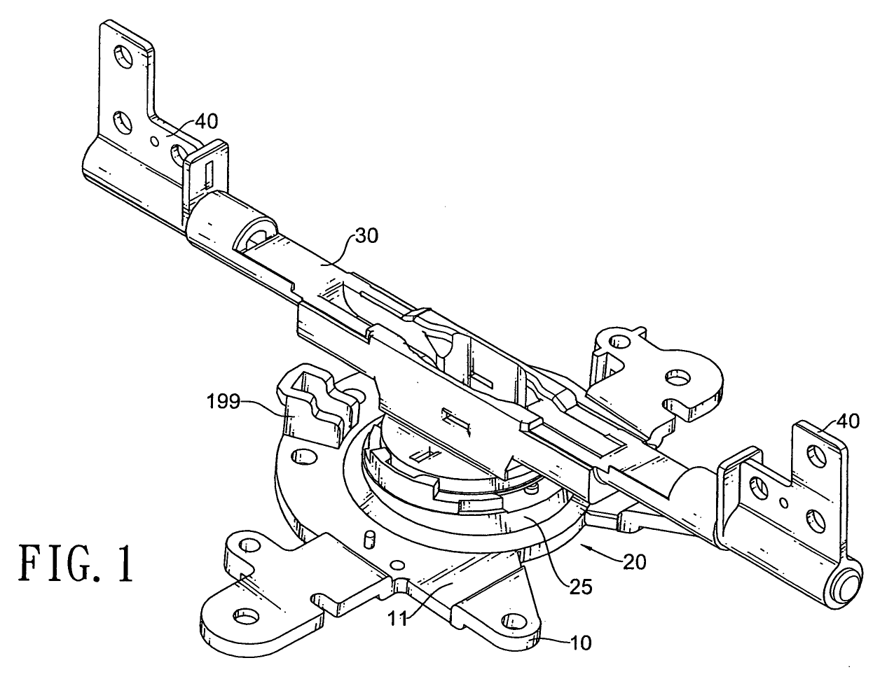

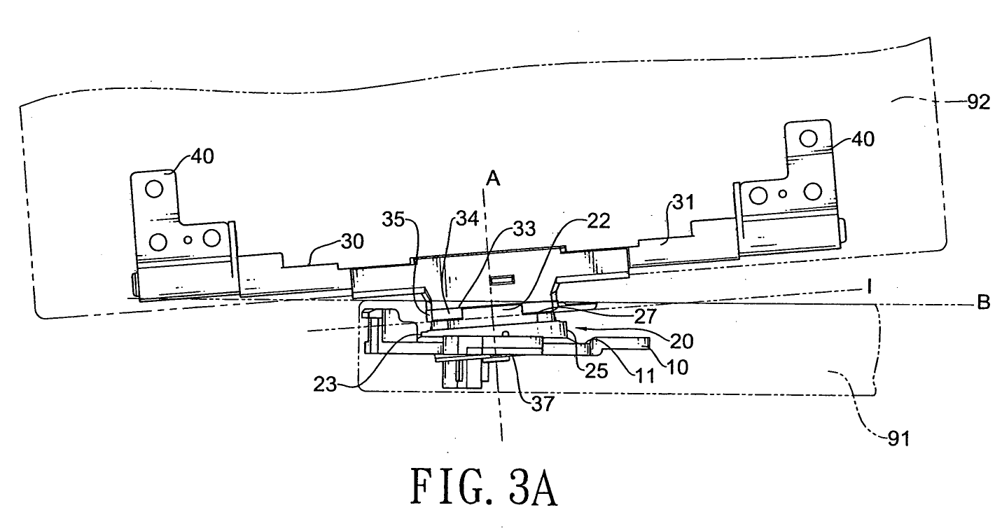

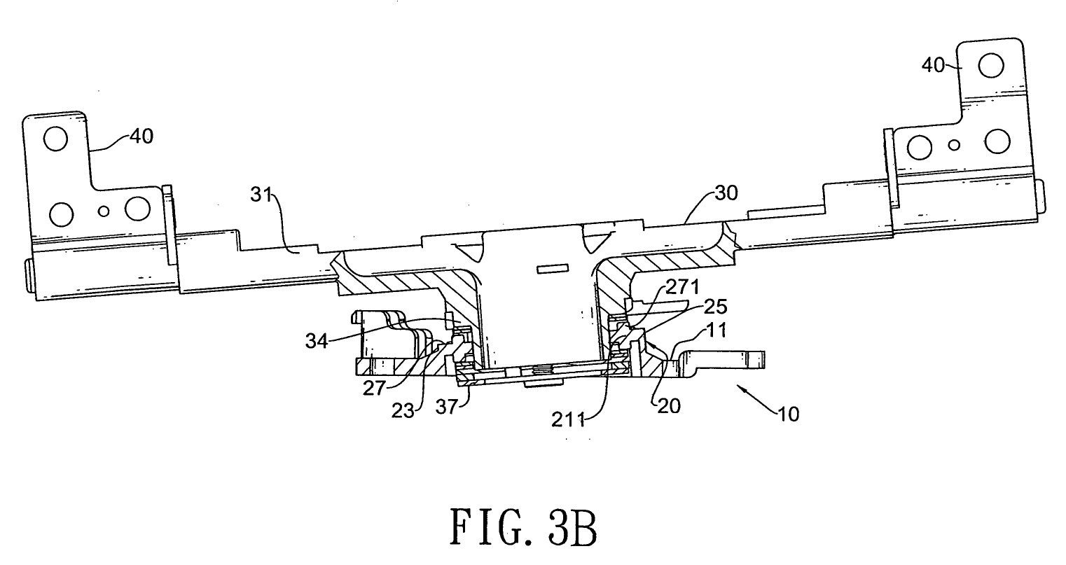

With reference to FIGS. 1 and 3A, a hinge in accordance with the present invention is mounted on a notebook having a base (91) and a display (92). The base (91) has a top, a keyboard and a base plane (B) that corresponds to the top of the base (91.). The display has two sides and a bottom edge. The hinge connects the display (92) pivotally and rotatably to the base (91) and comprises a stationary leaf (10), a bearing (20), a bracket (30) and two pivoting leaves (40).

The stationary leaf (10) is mounted on the base (91) and has a top surface (11), a front, a rear and may further have at least one bracket stop (199). The top surface (11) corresponds to the base plane (B). The bracket stop (199) is formed on and protrudes from the stationary leaf (10) at the rear.

With further reference to FIG. 3B, the bearing (20) is formed on and protrudes from the top surface (11) of the stationary leaf (10) and is inclined toward the rear of the stationary leaf (10).The bearing (20) has an axis (A), a gudgeon (21), a front (25), a rear (23) and an inclined top surface (27) and may further have multiple supports (271) and a limit (22).

The axis (A) is inclined relative to the top surface (11) of the stationary leaf(10).

The gudgeon (21), is a through hole, is defined through the bearing (20), corresponds to and parallel to the axis (A) and may have an inner surface and an inner annular flange (211). The inner annular flange (211) is formed on and protrudes radially inward from the inner surface of the gudgeon (21).

The front (25) has a height relative to the top surface (11) of the stationary leaf (10).

The rear (23) has a height relative to the top surface (11) of the stationary leaf (10). The height of the rear (23) is shorter than the height of the front (25).

The inclined top surface (27) is inclined relative to the top surface (11) of the stationary leaf (10), is perpendicular to the axis (A) and is parallel to an inclined plane (I).

The supports (271) are formed on and protrude from the inclined surface (27).

The limit (22) is formed on and protrudes from the inclined surface (27) and may be located on one of the supports (271).

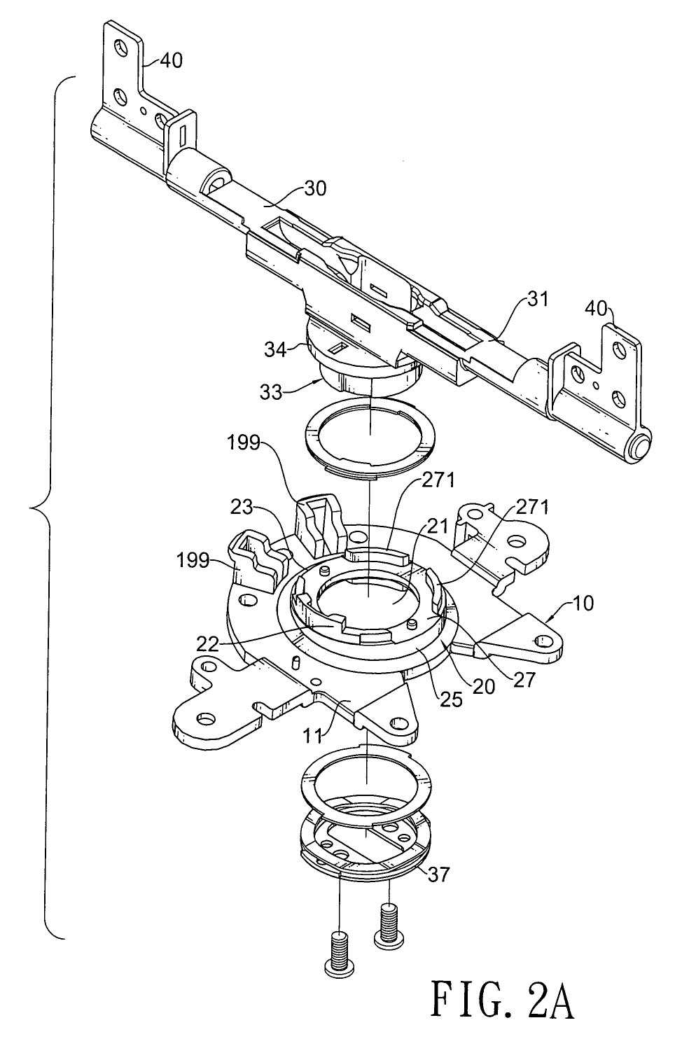

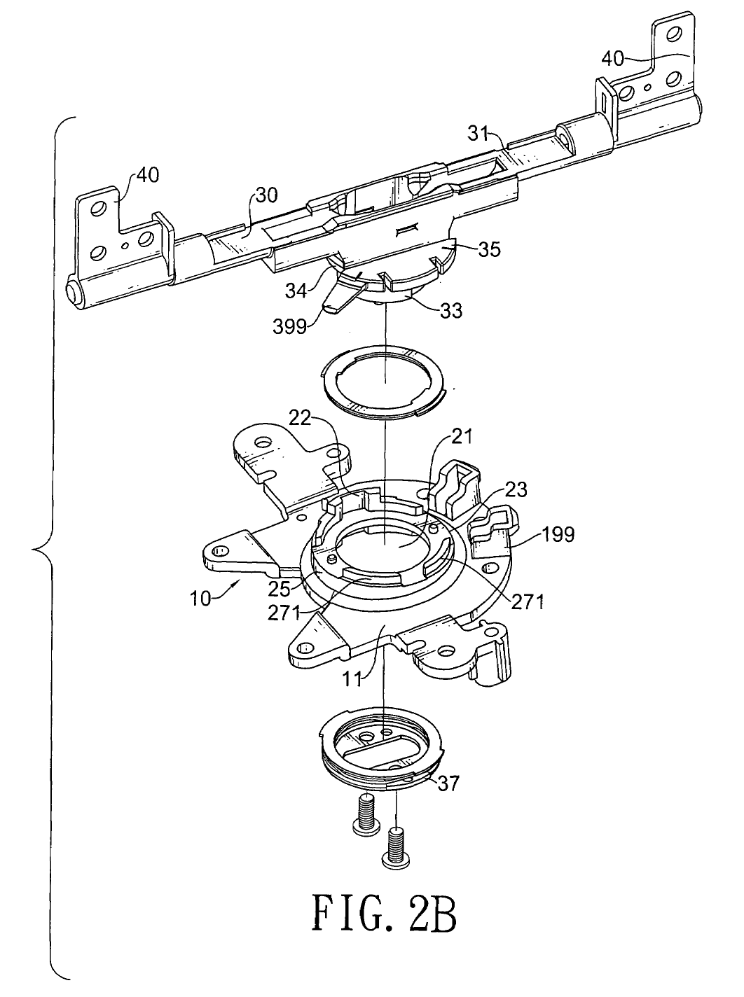

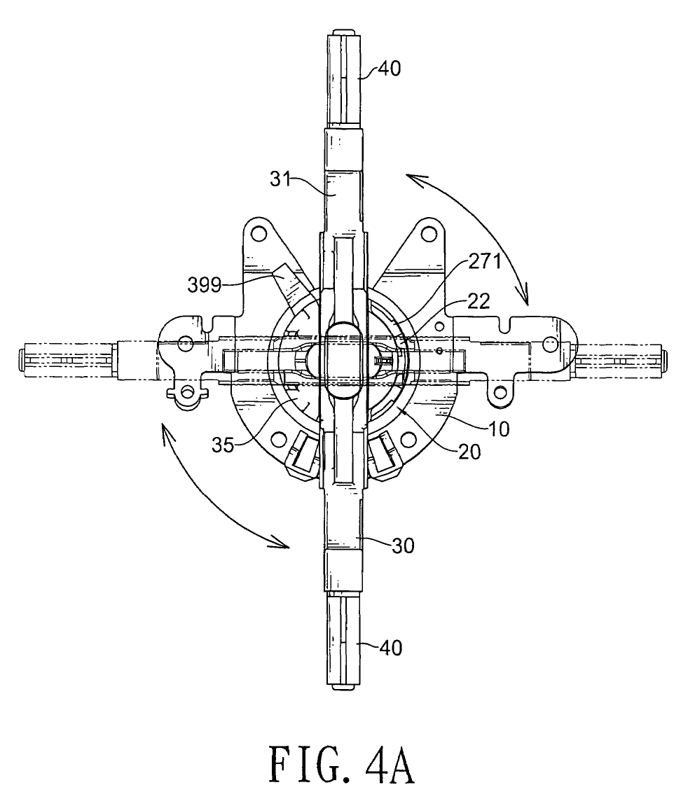

With further reference to FIGS. 2B and 4, the bracket (30) is mounted rotatably on the bearing (20)and has a beam (31) and a pintle (33) and may further have a lip (34), a limiting member (35), a limiting protrusion (399) and a disc (37).

The beam (31) is defined perpendicular to the axis (A) of the bearing (20) and has two ends and a medial section. The medial section is defined between the ends.

The pintle (33) is formed on and protrudes perpendicularly from the medial section of the beam (33), is mounted rotatably in the gudgeon (21) of the bearing (20) and has a bottom end.

The lip (34) is formed on and protrudes radially from the pintle (33) adjacent to the medial section and abuts the supports (271) on the bearing (20).

The limiting member (35) is formed on and protrudes radially from the pintle (33) and selectively abuts the limit (22) on the bearing (20) to prevent the bracket (30) from over rotating.

The limiting protrusion (399) is formed on and protrudes radially from the lip (34) of the bracket and selectively abuts one of the at least one bracket stop (199) of the stationary leaf (10).

The disc (37) is mounted on the bottom end of the pintle (33) of the bracket (30), abuts the inner annular flange (211) of the gudgeon (21) of the bearing (20) and holds the pintle (33) in the gudgeon (21).

Since the bearing (20) is mounted corresponding to the inclined plane (I), when the bracket (30) faces the front, the beam (31) is parallel to the base plane (B). However, when the bracket (30) is rotated ninety degrees the beam (31) is parallel with the inclined plane (I). Therefore, one end of the bracket (30) is not above the base (91) and is lower than the base plane (B), and the other end is located above the base (91) and higher than the base plane (B). Since the display (92) is mounted on the bracket (30), the bottom edge of the display will be parallel with the beam (31) and the previously described movement prevents the bottom edge of the display (92) from hitting the base.

The pivoting leaves (40) are rotatably mounted respectively around the ends of the beam (31) of the bracket (30), so that the display may pivot relative to the base (91).

The display of the notebook with the hinge can pivot and rotate smoothly without hitting the base of the notebook.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a stationary leaf having a front, a rear, a top surface;
a bearing being formed on and protruding from the top surface of the stationary leaf, inclined toward the rear of the stationary leaf and having
an axis inclined relative to the top surface of the stationary leaf;
a gudgeon define through the bearing and corresponding to and parallel to the axis;
a front having a height relative to the top surface of the stationary leaf;
a rear having a height relative to the top surface of the stationary leaf and being shorter than the height of the front; and
an inclined top surface inclined relative to the top surface of the stationary leaf and being perpendicular to the axis; and
a bracket mounted rotatably on the bearing and having
a beam being defined perpendicular to the axis of the bearing and having
two ends; and
a medial section being defined between the ends; and
a pintle being formed on and protruding perpendicularly from the medial section of the beam, being mounted rotatably in the gudgeon of the bearing and having a bottom end; and
two pivoting leaves being rotatably mounted respectively around the ends of the beam of the bracket.

2. The hinge as claimed in claim 1, wherein
the bearing further has multiple supports formed on and protruding from the inclined top surface; and
the bracket further has a lip formed on and protruding radially from the pintle adjacent to the medial section and abutting the supports on the bearing.

3. The hinge as claimed in claim 2, wherein
the bearing further has a limit being formed on and protruding from the inclined top surface; and
the bracket further has a limiting member being formed on and protruding radially from the pintle and selectively abutting the limit of the bearing.

4. The hinge as claimed in claim 3, wherein
the gudgeon of the bearing has an inner surface and an inner annular flange being formed on and protruding radially inward from the inner surface of the gudgeon; and
the bracket further has a disc mounted on the bottom end of the pintle on the bracket and abutting the inner annular flange in the gudgeon of the bearing.

5. The hinge as claimed in claim 4, wherein:
the stationary leaf further has at least one bracket stop formed on and protruding from the stationary leaf at the rear; and
the bracket further has a limiting protrusion formed on and protruding radially from the lip of the bracket and selectively abutting one of the at least one bracket stop.
